(19) United States
(12) Patent Application Publication
(10) Pub. No.: US 2002/0116224 A1
(43) Pub. Date: Aug. 22, 2002

(54) Networked expert system for the automated evaluation and quality control of medical point of care laboratory measuring data

(76) Inventors: Arne Hengerer, Erlangen (DE); Klaus Abraham-Fuchs, Erlangen (DE)

Correspondence Address: SCHIFF HARDIN & WAITE, 6600 SEARS TOWER, 233 S WACKER DR, CHICAGO, IL, 60606-6473, US

(21) Appl. No.: 09/784,721

(22) Filed: Feb. 15, 2001

(51) Int. Cl. G06F 17/60

(52) U.S. Cl. 705/3

(57) ABSTRACT

In a networked expert system for automated evaluation and quality control of medical point of care (POC) laboratory measuring data, whereby a POC measuring device in the practice of the treating physician is connected to an external central expert system via a data line or a network. The expert system functions as a virtual laboratory data collection and diagnosis system, and allows the treating physician to evaluate and judge the POC data, as well as to prepare treatment proposals due to implemented rules and, as warranted, augmented with a networking with storage systems containing the up-to-date medical knowledge and with electronic data banks for patient data.

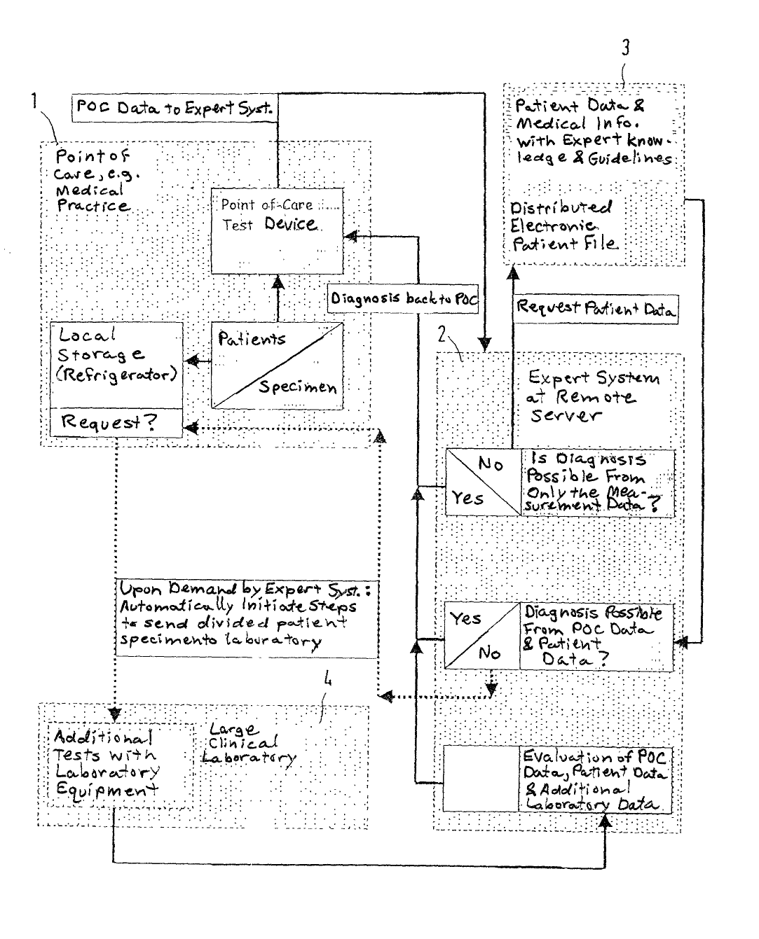

### BACKGROUND OF THE INVENTION

1. Field of the Invention

The present invention is directed to a networked expert system for automated evaluation and quality control of medical point of care laboratory measuring data

2. Description of the Prior Art

Centralized laboratory medicine is associated with a high logistical outlay. Specimen of patients must be sent fast and in a cooled condition to a central laboratory, since false diagnoses can occur if the cooling chain of the specimen, which is normally temperature-sensitive, is interrupted. It is significantly more cost-efficient, safe and lucrative for the physician in practice to examine the patient specimen on site, namely in the medical practice facility (since it is more cost-efficient to send patient data than to transport a patient specimen). Only a limited spectrum of the medically necessary laboratory examinations, however, can be carried out in the POC (“Point-of-Care”) diagnostics. Secondary examinations in technically better equipped central laboratories can become necessary if the test results are unclear. Secondary examinations in the central laboratory are associated with a considerable staff outlay and costs due to the logistics associated therewith (initial diagnosis that must ensue by the physician; proposing secondary examinations; sending the patient specimen; the communication of the measuring values). The cost saving potential of the POC, however, will not be effective with stand-alone instruments. The necessity of undertaking “extra” work, which, among other things, is a result of the considerable outlay with respect to unplanned (not foreseeable) secondary examinations, decreases the profitability of the physician in private practice. Further, the treating physician cannot be expected to have the necessary expert knowledge in all cases for purposes of interpreting the measurement values generated in his or her practice. Due to the explosion of knowledge in molecular medicine, for example, the physician cannot independently prepare “laboratory findings” in some cases and he then is dependent on the expert knowledge of a laboratory diagnostician. This is particularly true for genetic data, namely in connection with DNA chip diagnostics. This problem, which increases almost daily in modern medicine, requires new processes for preparing and evaluating laboratory-diagnostic data. In the future, for example, the laboratory physician can provide a colleague in private practice with expert knowledge by means of tele-medical communication auxiliary means.

### SUMMARY OF THE INVENTION

An object of the present invention is to provide a system which combines the advantages of the POC diagnostics,—namely the individualized patient examination and the absence of a necessity to send all patient specimens to a central diagnostics laboratory for analysis, with the advantages that expert knowledge offers in central diagnostics laboratories.

The object is inventively achieved in a system wherein the POC measuring device is connected via a data line or a network to an external central expert system, which also functions as a virtual laboratory data collection and diagnosis system, and which makes it possible for the physician to diagnose and judge the POC data and to prepare treatment proposals as a result of implemented rules, as well as when warranted, as a result of networking with storage systems containing up-to-date medical knowledge and with electronic data banks for patient data.

This networked expert system enables a significantly better utilization of fully automated diagnostics instruments that are appropriate for collecting the POC data, as will be commercially available in the next years. Then, every treating physician can carry out microbiological, hematological or chemical clinical examinations to a significant extent, wherein the diagnosis by the external central expert system is of critical importance, since the individual physician would be unable to meaningfully evaluate the larger volume of laboratory data acquired with new diagnostics instruments, without the necessary expert system.

The invention can be fashioned such that the expert system is connected to a central laboratory in order to automatically provide it with a listing of the necessary secondary examinations, if a divided (portioned) patient specimen is sent, when the diagnostic results are unclear.

Due to this networking with a central laboratory, patient specimens are automatically requested at the treating doctor and their further transport to the central laboratory is initiated, and secondary examinations can be specified, which should be initiated for clarifying a clinical picture in greater detail if the laboratory data are unclear, or if the findings cannot be recognized by the expert system on the basis of the laboratory data acquired at the treating doctor.

The inventive system allows a direct consultation of the treating physician by a laboratory physician or geneticist, for example via hotline or e-mail, which would be extremely time-inefficient and therefore difficult to be accepted, to be foregone. As a result of selected laboratory expert systems being kept up-to-date regarding the state of the art knowledge, the measurement values of the POC measuring devices can be evaluated online at the treating physician, and a central laboratory stuffed by experts only becomes involved in unclear cases.

The inventive tele-medical POC testing requires an integration of the three main components of a measuring device, an expert system and database management modules. Preferably, the POC measuring device is a simple arrangement of automatic machines established in the laboratory medicine with a specimen throughput capacity that is adapted to the medical practice and with a configurable interface. The data transmission preferably ensues by means of networks, such as the Internet. The measuring values, as well as all other confidential patient data are encoded and decoded in a data protection module. The expert system is preferably based on fuzzy logic, Bayes' networks, rule-based systems (for example Dr. Gait) or neural networks. The expert system not only considers the currently determined laboratory measuring values, but also combines them with up-to-date medical expert knowledge “Guidelines”, as they are available from “Data Warehouses”, for example, and are combined with patient-relevant data from electronic patient files. The electronic patient files are data banks for collecting all relevant patient medical information. These files can be centrally or decentrally organized. As described above, the data are transmitted via data lines or networks, whereby, in the latter case an encoding should always ensue. An authorization and identification that is optimally limited in terms of time and with regard to the sensitivity of the data preferably ensues dependent on consultation between the physician and the patient, by means of a chip-card-based system, for example.

The specimen containers with the patient specimen for the follow-up examination in the central laboratory are to be provided with an electronically readable identification imprint, for example with a bar-code, for the unambiguous identification thereof.

### DESCRIPTION OF THE DRAWINGS

The single FIGURE is a flowchart illustrating the operation of a networked expert system for the automated evaluation and quality control of medical point of care laboratory measurement data, in accordance with the principles of the present invention.

### DESCRIPTION OF THE PREFERRED EMBODIMENTS

### Case 1

The test is carried out in a point of care unit 1, such as a medical practice. The measurement values from the tests are transmitted to a central expert system via a data line or the Internet. Intelligent algorithms of an expert system assess the measuring result as being sufficient for preparing a definite diagnosis. The measuring result may also be interpreted dependent on data deposited in electronic data files 3. The treating physician receives a diagnosis proposal. Therapy concepts or background knowledge for the physician can be transmitted from a data warehouse, if needed. In an embodiment of the invention, a module of the data warehouse can initiate alerting the responsible agency (for example the Robert Koch Institut in Germany) given identification of diseases for which reporting is required. Further, the data warehouse can be utilized for collecting epidemiological studies. These makes it possible to recognize changing resistance situations (antibiotics and antiviral therapy) early or to recognize the development of endemics, epidemics, pandemics or tardive epidemics.

### Case 2

It is now assumed that the expert system interprets the measurement values of the tests collected analogously to case 1 as not being sufficient for preparing a well-grounded diagnosis. Reasons for this may be that control reactions of the test (positive or negative controls) or electronic controls of the device are recognized as incorrect or the supposition that a disease is present that cannot be identified in the POC unit 1. Moreover, the circumstance that the POC data do not provide any points of reference, which indicate a specific disease, even when it is probable due to other patient data, will not lead to a diagnosis proposal. In these cases, the expert system 2 initiates inquiries at central laboratories 4 with a certified competence regarding whether there is capacity for secondary examinations. These secondary examinations can be of alternative (same parameters are determined by means of a different method) or supplementary (parameters are measured that are not to be determined in the PCT testing) nature. Subsequent to a positive feedback, the sending of the patient specimen that has already been divided with respect to the POC testing is initiated in the POC unit 1, at the physician in private practice, for example. A courier service receives an order via Internet, for example. The selected central laboratory 4 receives a detailed questionnaire. After the patient specimen has been measured in the central laboratory 4, the newly generated data are transmitted to the expert system 2. When a diagnostic statement can be made with significant probability on the basis of the newly obtained measurement values, the treating physician receives a diagnosis proposal according to the model described in case 1. If further secondary examinations are necessary for purposes of preparing a sufficiently meaningful diagnosis, such further secondary examinations are initiated according to the format described above.

An analog model is possible for all forms of decentralized in vitro diagnostics, and therefore also is provided for home care diagnostics or in vitro diagnostics in intensive and emergency care.

Although modifications and changes may be suggested by those skilled in the art, it is the intention of the inventors to embody within the patent warranted hereon all changes and modifications as reasonably and properly come within the scope of their contribution to the art.

We claim as our invention:

1. A networked expert system for automatic evaluation and quality control of medical point of care laboratory measurement data, comprising:
a point of care measuring device disposed at a point of care which obtains point of care laboratory measurement data;
a central expert system, disposed remote from said location of point of care, and a data link, selected from the group consisting of a data line and a data network, connecting said central expert system to said point of care measuring device; and
said central expert system being accessible by a treating physician via said data link to function as a virtual laboratory data collection and diagnostic system for acting on said point of care laboratory measurement data to make an evaluation available to said treating physician based on said point of care laboratory measurement data.

2. A networked expert system as claimed in claim 1 wherein said point of care measuring device is disposed at a facility of a physician.

3. A networked expert system as claimed in claim 1 wherein said expert system is connected online to a central laboratory for automatically reporting back a listing to said treating physician of secondary examinations available for acting on said point of care laboratory measurement data if an initial evaluation at said expert system of said point of care laboratory measurement data does not produce a definitive diagnosis.

4. A networked expert system as claimed in claim 3 wherein the central laboratory reports the results of the secondary examinations to the expert system and the expert system re-evaluates the point of care laboratory measurement data by using the results of the secondary examinations.

5. A networked expert system as claimed in claim 3 wherein a request to the point of care is automatically made for providing a sample for the central laboratory.

6. A networked expert system as claimed in claim 1 further comprising a plurality of sub-systems forming said central expert system connected to each other via a data network using data encoding.

7. A networked expert system as claimed in claim 1 wherein said expert system includes a data bank containing up-to-date medical knowledge and patent data and acts on said point of care laboratory measurement data using said medical knowledge and said patient data.

8. A networked expert system as claimed in claim 6 wherein said central expert system includes means for limiting access to said up-to-date medical knowledge and patient data only to authorized persons.

9. A networked expert system as claimed in claim 7 further comprising, at said location of said treating physician, a chip card reader which requires insertion of a chip card of an authorized user in order to authorize access to said central expert system.

10. A networked expert system as claimed in claim 1 wherein said point of care measurement device comprises a container for obtaining a patient specimen having an electronically readable identifier thereon.

11. A networked expert system as claimed in claim 9 wherein said electronically readable identifier is a bar code.
